(19) United States
(12) Patent Application Publication
(10) Pub. No.: US 2024/0430963 A1
(43) Pub. Date: Dec. 26, 2024

(54) ENHANCED ROAMING BASED ON MULTI-LINK DEVICE (MLD)

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 18/750,958

(22) Filed: Jun. 21, 2024

Related U.S. Application Data
(60) Provisional application No. 63/510,070, filed on Jun. 23, 2023.
(60) Provisional application No. 63/649,902, filed on May 20, 2024.

(30) Foreign Application Priority Data
Jun. 17, 2024 (CN) 202410779620.3

(51) Int. Cl. H04W 76/15; H04W 48/20; H04W 88/10

(52) U.S. Cl. CPC H04W 76/15; H04W 48/20; H04W 88/10

(57) ABSTRACT

A first access point multi-link device (AP MLD) for connecting to a wireless network, the first AP MLD comprising: one or more APs affiliated with the first AP MLD, including a first AP; a processor coupled to the first AP, the processor configured to: communicate with a second AP MLD to determine that the first AP MLD is a roaming AP MLD, form affiliation with a second AP of one or more non-collocated APs affiliated with a second AP MLD, transmit information about the first AP affiliated with the first AP MLD to a non-AP MLD associated with the second AP MLD, associate with the non-AP MLD, and communicate with the non-AP MLD via the first AP MLD after the non-AP MLD performs roaming from the second AP MLD to the first AP MLD.

### CROSS-REFERENCE TO RELATED APPLICATIONS

This application claims benefit of U.S. Provisional Application No. 63/510,070, filed on Jun. 23, 2023, and U.S. Provisional Application No. 63/649,902, filed on May 20, 2024, in the United States Patent and Trademark Office, and China Patent Application No. 202410779620.3, filed on Jun. 17, 2024, in the China National Intellectual Property Administration, the entire contents of which are hereby incorporated by reference.

### TECHNICAL FIELD

The disclosure relates generally to wireless communication, and more particularly to, for example, but not limited to, enhanced roaming based on MLD.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

However, there is a general need for improved WLAN to support real-time applications or delay-sensitive applications that require strict requirements on the delay and packet loss ratio. These applications include online gaming, real-time video streaming, virtual reality, and remote-control drones and vehicles.

The description set forth in the background section should not be assumed to be prior art merely because it is set forth in the background section. The background section may describe aspects or embodiments of the present disclosure.

### SUMMARY

One aspect of the present disclosure provides a first access point multi-link device (AP MLD) for connecting to a wireless network, the first AP MLD comprising one or more APs affiliated with the first AP MLD, including a first AP and a processor coupled to the first AP. The processor is configured to: communicate with a second AP MLD to determine that the first AP MLD is a roaming AP MLD. The processor is configured to form affiliation with a second AP of one or more non-collocated APs affiliated with a second AP MLD. The processor is configured to transmit information about the first AP affiliated with the first AP MLD to a non-AP MLD associated with the second AP MLD. The processor is configured to associate with the non-AP MLD. The processor is configured to communicate with the non-AP MLD via the first AP MLD after the non-AP MLD performs roaming from the second AP MLD to the first AP MLD.

In some embodiments, the communicating with the second AP MLD to determine that the first AP MLD is the roaming AP MLD comprises receiving, from the second AP MLD, a frame that include information for determining which AP MLD can be the roaming AP MLD; and determining that the first AP MLD is the roaming AP MLD based on the information in the frame.

In some embodiments, the frame is a beacon frame.

In some embodiments, the frame includes traffic status information of the second AP MLD.

In some embodiments, determining that the first AP MLD is the roaming AP MLD comprises: comparing a stacked traffic amount of the first AP MLD with a stacked traffic amount indicated by the traffic status information of the second AP MLD, and determining that the first AP MLD is the roaming AP MLD if the stacked traffic amount of the first AP MLD is smaller than the stacked traffic amount of the second AP MLD.

In some embodiments, the frame includes buffer capacity information of the second AP MLD.

In some embodiments, determining that the first AP MLD is the roaming AP MLD comprises: comparing a size of a buffer of the first AP MLD with a buffer size indicated by the buffer capacity information of the second AP MLD, and determining that the first AP MLD is the roaming AP MLD if the size of the buffer of the first AP MLD is larger than the buffer size indicated by the buffer capacity information of the second AP MLD.

In some embodiments, associating with the non-AP MLD comprises performing at least one of authentication, security, and block acknowledgement agreement with the non-AP MLD.

One aspect of the present disclosure provides a non-access point multi-link device (non-AP MLD) for connecting to a wireless network, comprising processing circuitry. The processing circuitry is configured to associate with a first AP affiliated with a first AP MLD, communicate with the first AP affiliated with the first AP MLD. The processing circuitry is configured to receive information about a second AP MLD. The processing circuitry is configured to associate with a second AP affiliated with the second AP MLD and the first AP MLD, wherein the first AP and the second AP is non-collocated. The processing circuitry is configured to perform roaming from the first AP affiliated with the first AP MLD to the second AP affiliated with the second AP MLD. The processing circuitry is configured to communicate with the second AP affiliated with the second AP MLD.

In some embodiments, the processing circuitry is further configured to associate with the second AP affiliated with the second AP MLD by performing at least one of authentication, security, and block acknowledgement agreement with the second AP MLD.

In some embodiments, the processing circuitry is further configured to, during roaming, being active with both the first AP affiliated with the first AP MLD and the second AP affiliated with the second AP MLD.

In some embodiments, the processing circuitry is further configured to, after roaming, be active with only the second AP affiliated with the second AP MLD.

One aspect of the present disclosure provides computer-implemented method for facilitating communication in a wireless network, the method comprising: communicating, by a first access point (AP) affiliated with a first AP multi-link device (MLD), with a second AP MLD to determine that the first AP MLD is a roaming AP MLD; forming affiliations with a second AP of one or more non-collocated APs affiliated with a second AP MLD; transmitting information about the first AP affiliated with the first AP MLD to a non-AP MLD associated with the second AP MLD; associating with the non-AP MLD; and communicating with the non-AP MLD via the first AP MLD after the non-AP MLD performs roaming from the second AP MLD to the first AP MLD.

In some embodiments, the communicating with the second AP MLD to determine that the first AP MLD is the roaming AP MLD comprises: receiving, from the second AP MLD, a frame that include information for determining which AP MLD can be the roaming AP MLD, and determining that the first AP MLD is the roaming AP MLD based on the information in the frame.

In some embodiments, the frame is a beacon frame.

In some embodiments, the frame includes traffic status information of the second AP MLD.

In some embodiments, determining that the first AP MLD is the roaming AP MLD comprises: comparing a stacked traffic amount of the first AP MLD with a stacked traffic amount indicated by the traffic status information of the second AP MLD, and determining that the first AP MLD is the roaming AP MLD if the stacked traffic amount of the first AP MLD is smaller than the stacked traffic amount of the second AP MLD.

In some embodiments, the frame includes buffer capacity information of the second AP MLD.

In some embodiments, determining that the first AP MLD is the roaming AP MLD comprises: comparing a size of a buffer of the first AP MLD with a buffer size indicated by the buffer capacity information of the second AP MLD, and determining that the first AP MLD is the roaming AP MLD if the size of the buffer of the first AP MLD is larger than the buffer size indicated by the buffer capacity information of the second AP MLD.

In some embodiments, associating with the non-AP MLD comprises performing at least one of authentication, security, and block acknowledgement agreement with the non-AP MLD.

### BRIEF DESCRIPTION OF THE DRAWINGS

FIG. 1 illustrates an example of a wireless communication network in accordance with an embodiment.

FIG. 2 illustrates an example of a timing diagram of interframe space (IFS) relationships between wireless devices in accordance with an embodiment.

FIG. 3 illustrates examples of OFDM symbols and OFDMA symbols in accordance with an embodiment.

FIG. 4A illustrates an example of PPDU format in accordance with an embodiment. The PPDU may be used for SU and MU transmission.

FIG. 4B illustrates another example of PPDU format in accordance with an embodiment.

FIG. 5 illustrates a schematic diagram of an example of an electronic device in accordance with an embodiment.

FIG. 6 illustrates a schematic diagram of an example of a transmitter in accordance with an embodiment.

FIG. 7 illustrates a schematic diagram of an example of a receiver in accordance with an embodiment.

FIG. 8 illustrates the MLO operation with two links.

FIG. 9 illustrates an example of a roaming configuration.

FIG. 10 illustrates an example of normal MLD operation in accordance with an embodiment.

FIG. 11 illustrates a roaming AP MLD setup in accordance with an embodiment.

FIG. 12 illustrates an AP MLD A becomes a Roaming AP MLD, and APs affiliated with different AP MLD form a new affiliation with the Roaming AP MLD.

FIG. 13 illustrates a roaming mode setup in accordance with an embodiment.

FIG. 14 illustrates a roaming mode setup in accordance with an embodiment.

FIG. 15 illustrates an MLD configuration before roaming in accordance with an embodiment.

FIG. 16 illustrates an MLD configuration during roaming in accordance with an embodiment.

FIG. 17 illustrates an MLD configuration after roaming in accordance with an embodiment.

FIG. 18 illustrates a ladder diagram for configuring roaming between AP MLDs in accordance with an embodiment.

FIG. 19 illustrates a flow chart of an example process for roaming between AP MLDs in accordance with an embodiment.

### DETAILED DESCRIPTION

The detailed description provided below is intended to describe various implementations and is not intended to represent the sole implementation. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description below has been described with reference to a WLAN system based on the Institute of Electrical and Electronics Engineers (IEEE) 802.11 wireless standards, including the current and future amendments. However, a person having ordinary skill in the art will readily recognize that the teachings herein are applicable to other network environments, such as cellular telecommunication networks and wired telecommunication networks.

In some embodiments, apparatuses or devices such as an AP station and a non-AP station may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. Additionally, the apparatus may include one or more other hardware or software elements such as a network interface and a display device.

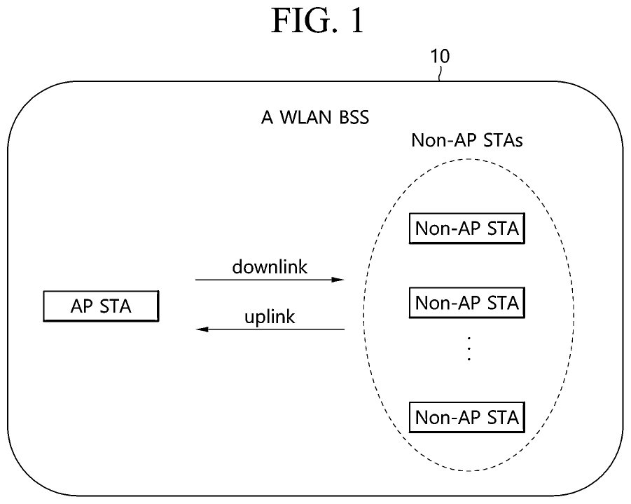

FIG. 1 illustrates an example of a wireless communication network in accordance with an embodiment. The wireless communication network may include a Basic Service Set (BSS) 10. The BSS 10 provides the basic organizational unit and includes a plurality of wireless devices which may be referred to as stations (STAs). In some implementations, the wireless device may include a plurality of STAs inside. The STA may be a logical entity that is a singly addressable instance of a medium access control (MAC) and physical layer (PHY) interface to the wireless medium (WM) according to IEEE 802.11 standards. The STA may be an access point (AP) STA and a non-AP STA. The AP STA may be an entity that contains one STA and provides access to the distribution system services via the wireless medium for associated STAs. The non-AP STA may be a STA that is not contained within an AP STA. The AP STA and the non-AP STA may be collectively called an STA. For simplicity of description, an AP STA may be referred to as an AP and a non-AP STA may be referred to as a STA or a station. The AP STA may comprise, be implemented as, or be included in a wireless device such as a centralized controller, a base station (BS), a node-B, a base transceiver system (BTS), a site controller, a network adapter, and a router. Similarly, the non-AP STA may comprise, be implemented as, or be included in a wireless communication device such as a terminal, a wireless transmit/receive unit (WTRU), a user equipment (UE), a mobile station (MS), a mobile terminal, a mobile subscriber unit, a laptop, a smartphone, a battery pack, and a non-mobile computing device.

Referring to FIG. 1, the BSS 10 in the wireless communication network may include an AP STA 11 and a plurality of non-AP STAs 12. The AP STA 11 may transmit information to a single station among the non-AP STAs 12 or may simultaneously transmit information to two or more stations among the non-AP STAs 12. The AP STA 11 may use, for the simultaneous transmission, Downlink (DL) multi-user (MU) transmission scheme such as DL OFDMA (Orthogonal Frequency Division Multiplexing Access) and DL MU-MIMO (Multi-User Multi-Input-Multi-Output). Similarly, each of the non-AP STAs 12 may individually transmit information to an AP STA or may simultaneously transmit information along with one or more other non-AP STAs 12. The non-AP STAs 12 may use, for the simultaneous transmission, Uplink (UL) MU transmission scheme such as UL OFDMA and UL MU-MIMO. In MU-MIMO transmission, a transmitting station may simultaneously transmit information to a plurality of receiving stations using one or more antennas over the same subcarriers. Different spatial streams may be used as the different resources in the MU-MIMO transmission. In OFDMA transmission, a transmitting station may simultaneously transmit information to a plurality of receiving stations over different groups of subcarriers. Different frequency (subcarriers) may be used as the different resource in the OFDMA transmission.

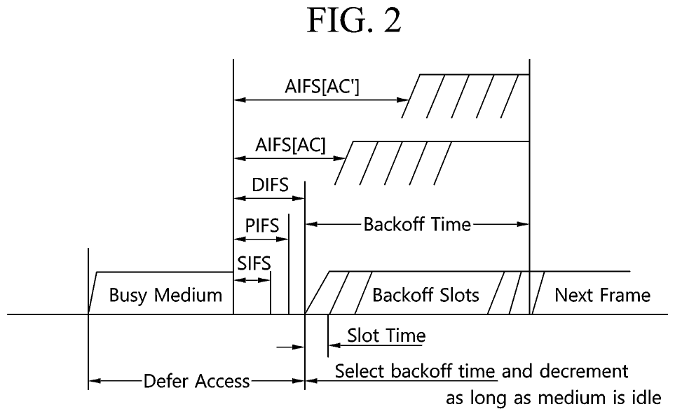

FIG. 2 illustrates an example of a timing diagram of interframe space (IFS) relationships between wireless devices in accordance with an embodiment. FIG. 2 depicts a CSMA (carrier sense multiple access)/CA (collision avoidance) frame transmission procedure to prevent collision between frames on a channel. These frames may include a data frame, a control frame, or a management frame that are exchanged among wireless devices.

The data frame may be used for transmission of data forwarded to a higher layer in a receiving station. In FIG. 2, access to the medium by wireless devices is deferred while the medium is busy until an IFS duration has elapsed. For example, a wireless device may transmit a data frame after completing a backoff period when a Distributed Coordination Function (DCF) IFS (DIFS) has expired. The management frame may be used for exchanging management information which is not forwarded to the higher layer in a receiving station. The management frame includes a beacon frame, an association request/response frame, disassociation frame, reassociation request/response frame, a probe request/response frame, and an authentication request/response frame and action frame. The control frame may be used for controlling access to the medium. The control frame includes a request to send (RTS) frame, a clear to send (CTS) frame, and an acknowledgment (ACK) frame, BlockAck request/response frame, NDP (Null Data PPDU) Announcement frame. If the control frame is not a response frame to another frame, the wireless device may transmit the control frame after performing backoff operation when the DIFS has elapsed. However, if the control frame is a response frame to another frame, the wireless device may transmit the control frame without performing backoff operation when a short IFS (SIFS) has elapsed. Furthermore, a QoS (Quality of Service) STA may transmit a frame after performing backoff operation when an arbitration IFS (AIFS) for access category (AC) (i.e., AIFS [AC]) has elapsed. In some embodiments, a point coordination function (PCF) enabled AP STA may transmit the frame after performing backoff operation when a PCF IFS (PIFS) has elapsed. The PIFS duration may be less than the DIFS duration, but greater than the SIFS duration.

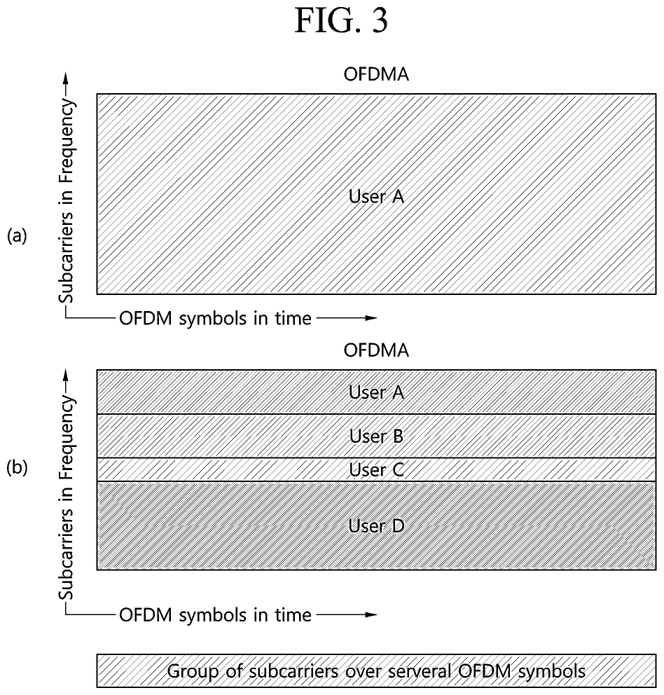

FIG. 3 illustrates examples of OFDM symbols and OFDMA symbols in accordance with an embodiment. In FIGS. 3(a) and 3(b), OFDM/OFDMA symbols are illustrated along the time dimension and subcarriers are illustrated along the frequency dimension.

The OFDMA was introduced in IEEE 802.11ax standard which is also known as High Efficiency (HE) WLAN. The OFDMA will be also used in next amendments to IEEE 802.11 standard such as Extreme High Throughput (EHT) WLAN. One or more STAs may be allowed to use one or more resource units (RUs) throughout operating bandwidth to transmit data at the same time. The RU may be a group of subcarriers as an allocation for subcarriers for transmission. In some aspects, non-AP STAs may be associated or non-associated with AP STA when transmitting response frames simultaneously in assigned RUs after a specific period of time such as SIFS. The SIFS may be the time from the end of the last symbol, or signal extension if present, of the previous frame to the beginning of the first symbol of the preamble of the subsequent frame.

The OFDMA is an OFDM-based multiple access scheme where different groups of subcarriers are allocated to different users, which allows simultaneous transmission to one or more users with high accurate synchronization for frequency orthogonality. The OFDMA allows users to be allocated to different groups of subcarriers in each PPDU (physical layer protocol data unit). An OFDM symbol in the OFDMA may include a plurality of subcarriers depending on the bandwidth of the PPDU. The difference between OFDM and OFDMA is illustrated in FIG. 3. As shown in FIG. 3(a), the OFDM symbol includes one single user (User A), while the OFDMA symbol includes a plurality of users (User A, User B, User C, and User D) and each user is assigned and allocated into different group of subcarriers as shown in FIG. 3(b).

In the case of UL MU transmission, the AP STA may control the medium by using more scheduled access mechanism which allows AP STAs and non-AP STAs to use OFDMA and MU-MIMO. A UL MU PPDU may be sent by non-AP STAs as a response to a trigger frame sent by the AP STA. The trigger frame may have information for receiving STAs and assign a single or multiple RU to the receiving STAs. It allows non-AP STAs to transmit OFDMA-based frame in the form of trigger-based (TB) PPDU (e.g., HE TB PPDU or EHT TB PPDU) where an operating bandwidth is segmented into a plurality of RUs and each RU serves as responses to the trigger frame. For simplicity of description, a single RU and a multiple RU (MRU) which are allocated into a non-AP STA may be collectively referred to as an RU. In some embodiments, the MRU may indicate the combination of two RUs.

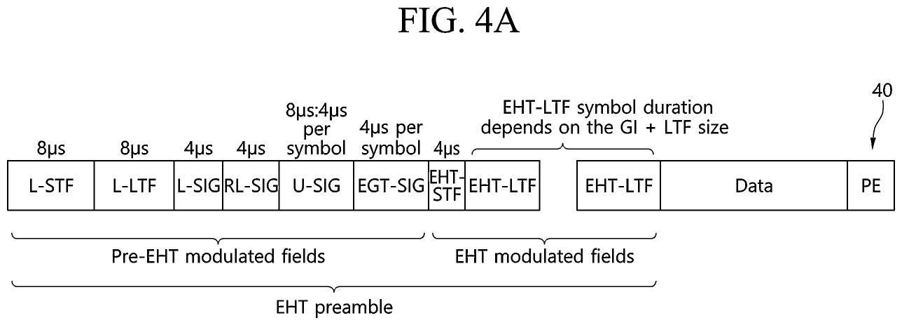

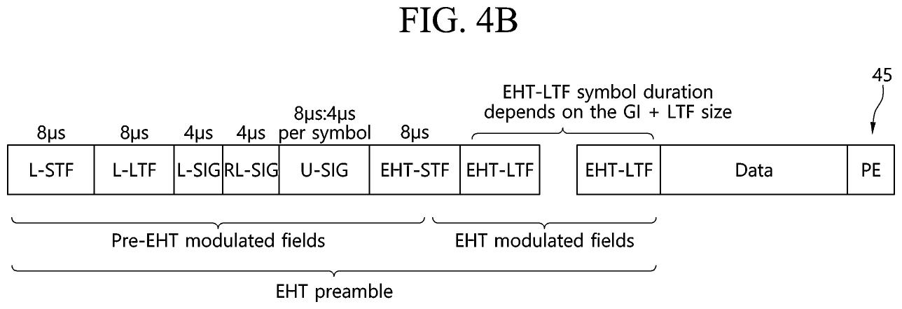

FIG. 4A illustrates an example of PPDU format in accordance with an embodiment. The PPDU may be used for SU and MU transmission. The PPDU may be used as EHT MU PPDU in accordance with IEEE 802.11be or may be used as a PPDU in accordance with any future amendments to the IEEE 802.11 standard.

Referring to FIG. 4A, the EHT MU PPDU 40 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a legacy short training field (L-STF), a legacy long training field (L-LTF), a legacy signal (L-SIG) field, a repeated legacy signal (RL-SIG) field, a universal signal (U-SIG) field and a EHT signal (EHT-SIG) field. The EHT modulated fields may include an EHT short training field (EHT-STF) and one or more EHT long training fields (EHT-LTFs).

The L-STF may be utilized for packet detection, automatic gain control (AGC) and coarse frequency-offset correction. The L-LTF may be utilized for channel estimation, fine frequency-offset correction, and symbol timing. The L-SIG field may provide information for communication such as data rate, a length related to the EHT PPDU 40. The RL-SIG field may be a repeat of the L-SIG field and may be used to differentiate an EHT PPDU from other PPDUs conforming to other IEEE 802.11 standards such as IEEE 802.11a/n/ac. The U-SIG field may provide information necessary for receiving STAs to interpret the EHT MU PPDU. The EHT-SIG may provide additional information to the U-SIG field for receiving STAs to interpret the EHT MU PPDU 40. For simplicity of description, the U-SIG field, the EHT-SIG field or both may be referred to herein as the SIG field. EHT-LTFs may enable receiving STAs to estimate the MIMO channel between a set of constellation mapper output and the receive chains. The data field may carry one or more PHY service data units (PSDUs). The PE field may provide additional receive processing time at the end of the EHT MU PPDU.

FIG. 4B illustrates another example of PPDU format in accordance with an embodiment. The PPDU in FIG. 4B may be used for SU and MU transmission. The PPDU 45 may be used as EHT TB (Trigger-based) PPDU in accordance with IEEE 802.11be or may be used as a PPDU conforming to any of future amendments to the IEEE 802.11 standard. In some embodiments, the EHT TB PPDU 45 is used for transmission by non-AP STA that is a response to a triggering frame from an AP STA.

As shown in FIG. 4B, the EHT TB PPDU 45 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a L-STF field, a L-LTF field, a L-SIG field, a RL-SIG field, a U-SIG field. The EHT modulated fields may include an EHT-STF and one or more EHT-LTFs. Unlike the EHT MU PPDU 40, the EHT-SIG may not be present in the EHT TB PPDU 45. Instead, the duration (8 us) of the EHT-STF of the EHT TB PPDU 45 may be twice the duration (4 us) of the EHT-STF of the EHT MU PPDU 40. Detailed description for the other fields in the EHT TB PPDU 45 will be omitted since the description for each field in the EHT MU PPDU 40 can be applied to each corresponding field of the EHT TB PPDU 45.

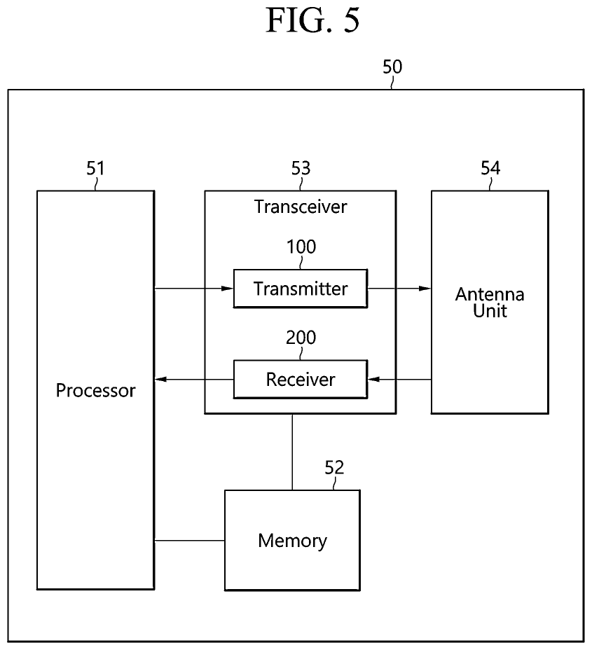

FIG. 5 illustrates a schematic diagram of an example of an electronic device in accordance with an embodiment. The electronic device 50 may be an example of the AP STA 11 or non-AP STA 12 shown in FIG. 1.

Referring to FIG. 5, the electronic device 50 may include a processor 51, a memory 52, a transceiver 53, and an antenna unit 54. The transceiver 53 may include a transmitter 100 and a receiver 200.

The processor 51 may perform medium access control (MAC) functions, PHY functions, RF functions, or a combination of some or all of the foregoing. In some embodiments, the processor 51 may comprise some or all of a transmitter 100 and a receiver 200. The processor 51 may be directly or indirectly coupled to the memory 52. In some embodiments, the processor 51 may include one or more processors.

The memory 52 may be non-transitory computer-readable recording medium storing instructions that, when executed by the processor 51, cause the electronic device 50 to perform operations, methods or procedures set forth in the present disclosure. In some embodiments, the memory 52 may store instructions that are needed by one or more of the processor 51, the transceiver 53, and other components of the electronic device 50. The memory may further store an operating system and applications. The memory 52 may comprise, be implemented as, or be included in a read-and-write memory, a read-only memory, a volatile memory, a non-volatile memory, or a combination of some or all of the foregoing.

The antenna unit 54 includes one or more physical antennas. When MIMO or MU-MIMO is used, the antenna unit 54 may include more than one physical antenna.

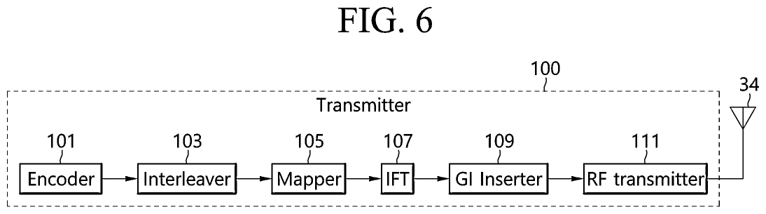

FIG. 6 illustrates a schematic diagram of an example of a transmitter in accordance with an embodiment. The transmitter in FIG. 6 may be an example of the transmitter illustrated in FIG. 5.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder. The interleaver 103 may interleave bits of encoded data from the encoder 101 to change the order of bits, and output interleaved data. In some embodiments, interleaving may be applied when BCC encoding is employed. The mapper 105 may map interleaved data into constellation points to generate a block of constellation points. If the LDPC encoding is used in the encoder 101, the mapper 105 may further perform LDPC tone mapping instead of the constellation mapping. The IFT 107 may convert the block of constellation points into a time domain block corresponding to a symbol by using an inverse discrete Fourier transform (IDFT) or an inverse fast Fourier transform (IFFT). The GI inserter 109 may prepend a GI to the symbol. The RF transmitter 111 may convert the symbols into an RF signal and transmits the RF signal via the antenna unit 34.

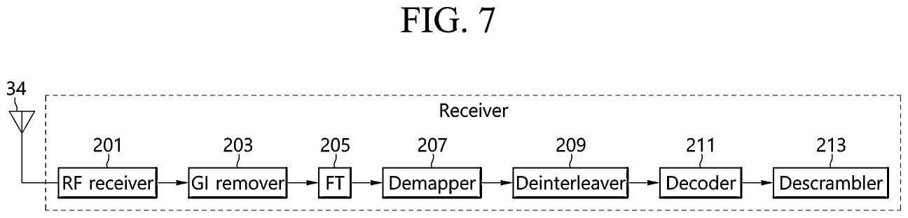

FIG. 7 illustrates a schematic diagram of an example of a receiver in accordance with an embodiment. The receiver in FIG. 7 may be an example of the receiver illustrated in FIG. 5.

Referring to FIG. 7, the receiver 200 in accordance with an embodiment may include a RF receiver 201, a GI remover 203, a Fourier transformer (FT) 205, a demapper 207, a deinterleaver 209, and a decoder 211. The RF receiver 201 may receive an RF signal via the antenna unit 34 and converts the RF signal into one or more symbols. The GI remover 203 may remove the GI from the symbol. The FT 205 may convert the symbol corresponding to a time domain block into a block of constellation points by using a discrete Fourier transform (DFT) or a fast Fourier transform (FFT) depending on implementation. The demapper 207 may demap the block of constellation points to demapped data bits. If the LDPC encoding is used, the demapper 207 may further perform LDPC tone demapping before the constellation demapping. The deinterleaver 209 may deinterleave demapped data bits to generate deinterleaved data bits. In some embodiments, deinterleaving may be applied when BCC encoding is used. The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data. The descrambler 213 may descramble the descrambled data bits based on a scrambler seed.

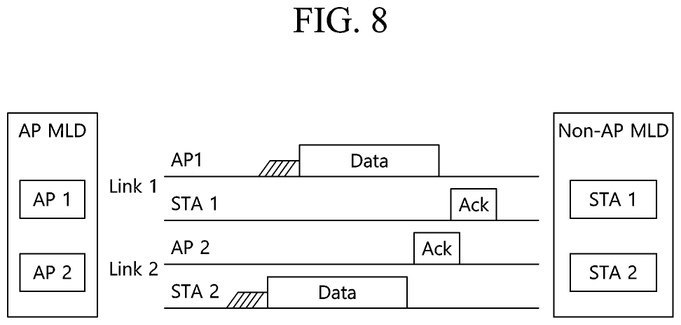

The IEEE 802.11be Extremely High Throughput (EHT) task group is developing the next generation Wi-Fi standard to achieve higher data rate, lower latency, and more reliable connection to enhance user experience. One of the key features of Wi-Fi 7 is Multi-Link Operation (MLO). As most current APs and stations (STAs) incorporate dual-band or tri-band capabilities, the newly developed MLO feature enables packet-level link aggregation in the MAC layer across different PHY links. By performing load balancing according to traffic requirements, MLO achieves significantly higher throughput and lower latency for enhanced reliability in a heavily loaded network. With MLO capability, a Multi-Link Device (MLD) may include multiple “affiliated” devices to the upper logical link control (LLC) layer, allowing concurrent data transmission and reception in multiple channels across a single or multiple frequency bands in 2.4 GHz, 5 GHz and 6 GHz. FIG. 8 illustrates the MLO operation with two links. As illustrated, AP MLD includes affiliated AP 1 and AP 2. Non-AP MLD includes affiliated STA 1 and STA 2. AP1 is associated with STA 1 on link 1 and AP 2 is associated with STA 2 on link 2. As illustrated, AP 1 may transmit a data frame to STA 1 via link 1, STA 1 may transmit an acknowledgement frame to AP 1 via link 1 in response to the data frame, STA 2 may transmit a data frame via link 2 to AP 2, and AP 2 may transmit an acknowledgement frame via link 2 to STA 2 in response to the data frame. The AP MLD and the Non-AP MLD can transmit and receive simultaneously in link 1 and link 2.

There exists Wi-Fi technologies that allow a device to connect to a single link and the deivce is capable of switching among 2.4 GHz, 5 GHz and 6 GHz bands. However, such Wi-Fi devices typically have a switching overhead or delay of up to 100 ms. Therefore, MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, a MLD transmits frames asynchronously across multiple links without aligning the starting time. In contrast, in synchronous transmission mode the starting time are aligned across the links. In either mode, the links can have their own primary channel and parameters, including Packet Protocol Data Unit (PPDU), Modulation and Coding Scheme (MCS), Enhanced Distributed Channel Access (EDCA), among others.

With the popularity and growth of wireless systems, applications are being developed and commercialized that require using low latency traffic in order to provide proper functionality. As described, these applications can include virtual reality/augmented reality (VR/AR), which ingest real-time data from different sources to provide visualizations. Other applications can include immersive gaming, remote office, and cloud-computing, among various other applications that require more challenging time-sensitive technologies. Accordingly, various technologies are being developed in order to support low latency traffic.

The techniques of STAs moving from a basic service set (BSS) to another BSS has been a long standing issue that has been addressed using various solutions. There is Fast Transition (FT) Protocol to solve it in Wi-Fi system. However, wireless systems may still experience a break in transmitting and/or receiving data during a roaming due to authentication and reassociation procedures (with additional delay).

Accordingly, some embodiments provide for enhanced roaming with reduced data transmission delay.

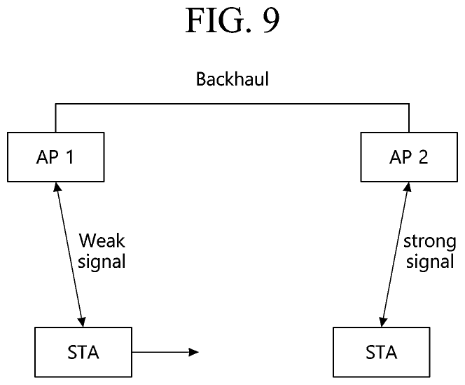

Current roaming techniques may present various problems. In particular, in the configuration of FIG. 9, when a link with AP 1 deteriorates and the signal with AP 2 grows stronger, the STA roams to AP 2 and then the STA reassociates with AP 2 (e.g., over-the-air case in fast transition (FT)). After successful setup and authentication, the STA negotiates some agreements with AP 2 such as a Block Acknowledgement (BA) agreement and/or security agreement.

Therefore, when the STA roams between multiple APs, the STA needs to reassociate with the target AP and perform a 4-way handshake in FT and the network needs to switch the data path in a break-before-make manner, which leads to data interruption and extra delay during roaming.

Many embodiments address these problems of current roaming techniques, where the contexts of association, authentication and BA agreement need to be maintained and the data path to exchange frames during roaming needs to be enabled.

Some embodiments provide for enhanced roaming based on MLO and can leverage existing MLO frameworks.

The MLO defined in IEEE 802.11be already allows a non-AP MLD to switch links with minimal signaling overhead and delay.

Accordingly, many embodiments provide for seamless roaming to another AP with minimal communication interruption based on MLO.

In some embodiments, there is a wireless communication device that supports multi-link operation (MLO), which may be defined as multi-link device (MLD). Both AP and STA can have MLD capabilities. An AP supporting MLO may be referred to as an AP MLD and an STA supporting MLO may be referred to as a non-AP MLD. There are a number of AP MLDs which can communicate with each other.

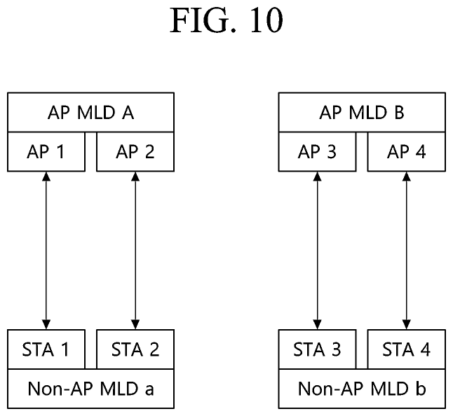

Before the roaming operation, each AP MLD may operate its own BSS. FIG. 10 illustrates an example of normal MLD operation in accordance with an embodiment. In particular, each AP MLD may operate its own BSS. STA 1 and STA 2 are affiliated with non-AP MLD a has an association with AP 1 and AP 2 respectively affiliated with AP MLD A. STA 3 and STA 4 affiliated with non-AP MLD b has an association with AP 3 and AP 4 respectively affiliated with AP MLD A.

To enable roaming operation, one of these AP MLDs can be a Roaming AP MLD.

The Roaming AP MLD may be determined based on the information which is exchanged between the AP MLDs. The information may be related to a current traffic status and buffer capacity in each AP MLD among other types of information.

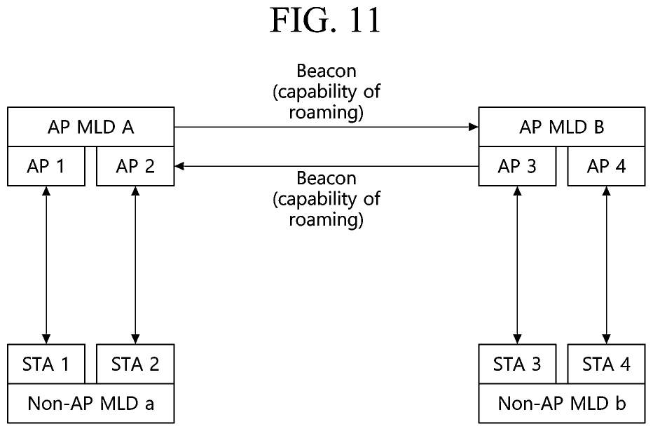

Some embodiments can include various procedures for roaming AP MLD setup. FIG. 11 illustrates a roaming AP MLD setup in accordance with an embodiment. AP 1 and AP 2 are affiliated with AP MLD A and AP 3 and AP 4 are affiliated with AP MLD B. STA 1 and STA 2 are affiliated with Non-AP MLD a and STA 3 and STA 4 are affiliated with Non-AP MLD b. AP MLD A is associated with Non-AP MLD a and AP MLD B is associated with Non-AP MLD b. AP MLD A may transmit one or more beacon frames to AP MLD B and AP MLD B may transmit one or more beacon frames to AP MLD A. The beacon frame may be transmitted by AP 1 and/or AP2 for AP MLD A. The beacon frame may be transmitted by AP3 and/or AP4 for AP MLD B.

The beacon frames may include information to notify other nearby AP MLDs that the AP MLD transmitting a beacon frame has the capability of supporting roaming operation and can be candidate of Roaming AP MLD. The information may include traffic status and buffer capacity, among other types of information.

Some embodiments may compare the stacked traffic of the buffer in AP MLD A with the stacked traffic in AP MLD B, and the AP MLD with a larger buffer size or a smaller amount of stacked traffic can become Roaming AP MLD.

In some embodiments, the Roaming AP MLD may form a new affiliation with APs that are affiliated with the other AP MLD.

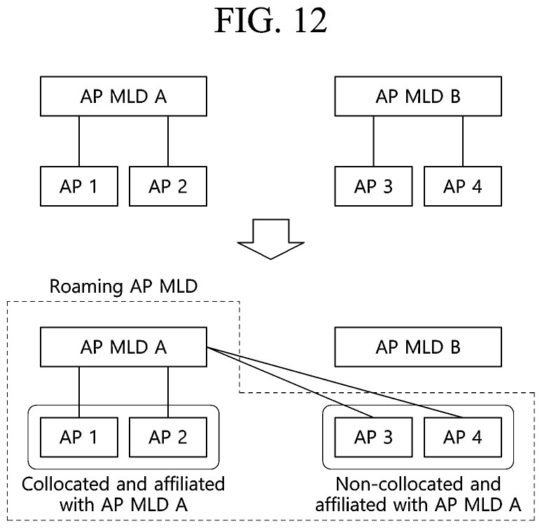

FIG. 12 illustrates if AP MLD A becomes the Roaming AP MLD, AP 3 and AP 4 affiliated with AP MLD B should form a new affiliation with AP MLD A. Therefore, collocated AP 1 and 2 and non-collocated AP 3 and 4 may be affiliated with the Roaming AP MLD.

In some embodiments, the BA agreement is negotiated between an STA affiliated with non-AP MLD and AP 1, AP 2, AP 3, or AP 4 affiliated with the roaming AP MLD if the non-AP MLD supports the roaming. The context of association, security, BA sessions may be maintained between the roaming AP MLD and non-AP MLD.

Described now are operations of an STA affiliated with a non-AP MLD to support roaming. In some embodiments, before roaming mode, the non-AP MLD may perform an association with an AP affiliated with an AP MLD. As illustrated in FIG. 10, if the number of supported links in AP MLD is 2, non-AP MLD forms an association for the two links.

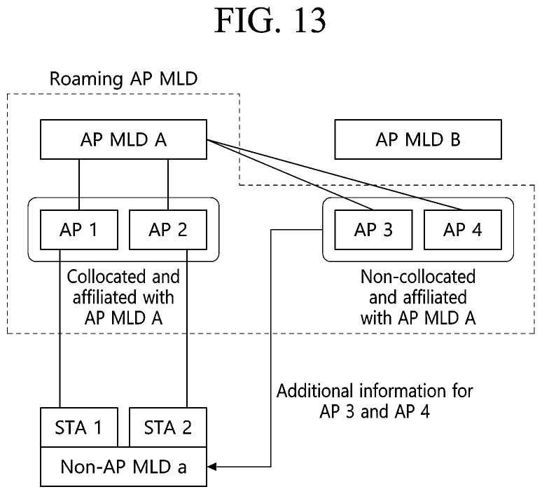

FIG. 13 illustrates a roaming mode setup in accordance with an embodiment. As illustrated, during the roaming mode setup, STA 1 and STA 2 affiliated with non-AP MLD a may be associated with AP MLD A. When AP MLD A becomes the Roaming AP MLD, STA 1 and 2 receive the additional information for links corresponding to AP 3 and 4 which were affiliated with AP MLD B. In some embodiments, STA 1 and STA 2 may receive a frame (e.g., a probe response frame, among others) including the additional information from AP 1 and/or AP 2. In some embodiments, STA 1 and STA 2 may receive a frame (e.g., a probe response frame, among others) including the additional information from AP 3 and/or AP 4. STA 1 and STA2 affiliated with non-AP MLD a do not need to form an association with AP MLD A because that has already been previously formed.

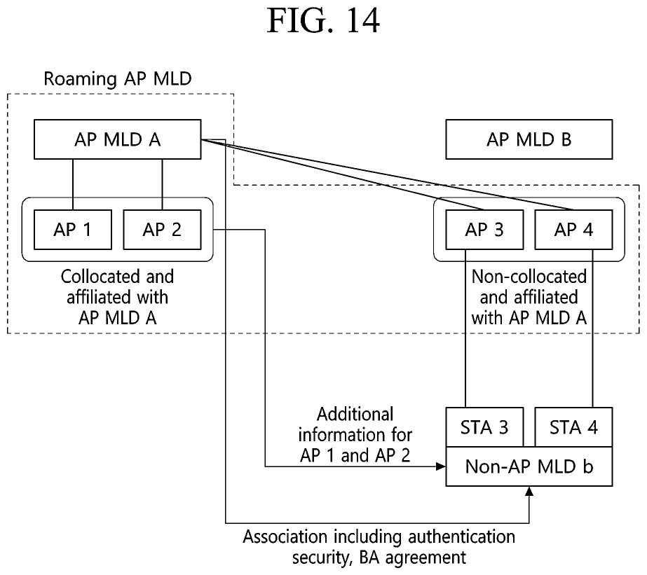

FIG. 14 illustrates a roaming mode setup in accordance with an embodiment. As illustrated, AP 1 and AP2 are affiliated with AP MLD A and AP 3 and AP 4 are affiliated with AP MLD B. STA 3 and STA 4 are affiliated with non-AP MLD b which is associated with AP MLD B. When AP MLD A becomes the Roaming AP MLD, STA 3 and STA 4 form new associations with AP MLD A (which is Roaming AP MLD) including authentication, security, BA agreement, among others. STA3 and STA 4 affiliated with Non-AP MLD b need to form association with AP MLD A because it has not been formed.

The information exchanged during association between non-AP MLD b and AP MLD A (Roaming AP MLD) include the additional information for AP 1 and AP 2. Accordingly, AP3 and AP4 are non-collocated and affiliated with AP MLD A.

After the described roaming setup, roaming operation may be enabled.

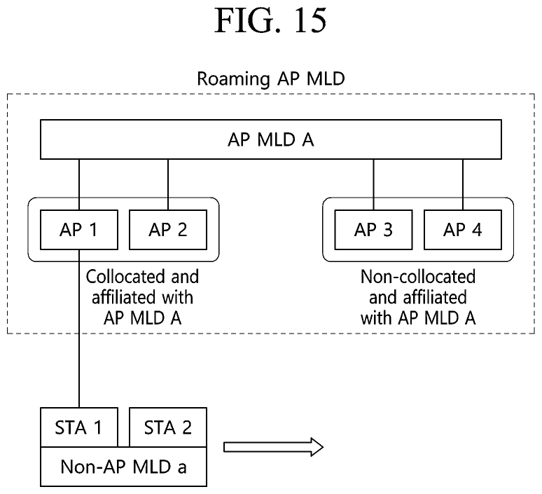

FIG. 15-17 illustrate a configuration before, during, and after roaming setup in accordance with an embodiment.

FIG. 15 illustrates a configuration before roaming in accordance with an embodiment. As illustrated AP MLD A includes AP1 and AP2 that are collocated and affiliated with AP MLD A, and AP3 and AP 4 that are non-collated and affiliated with AP MLD A. Non-AP MLD A is affiliated with STA 1 and STA 2. STA 1 in non-AP MLD a is active with AP 1 in AP MLD A and a data path is routed to AP 1 in AP MLD A. AP 1 may host context of AP MLD A (which is Roaming AP MLD) for the client,

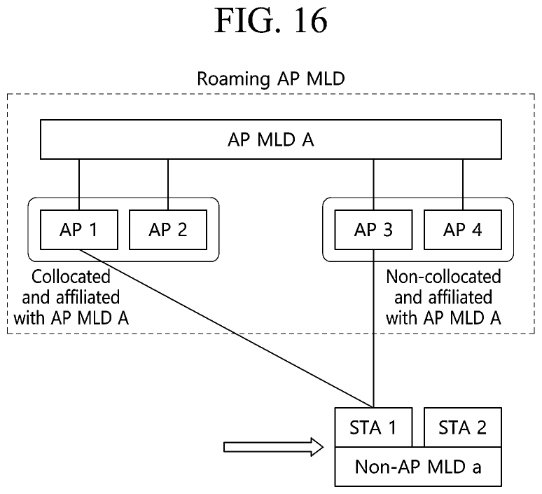

FIG. 16 illustrates the configuration during roaming in accordance with an embodiment. STA 1 in non-AP MLD a is active with both AP 1 and AP 3 in Roaming AP MLD.

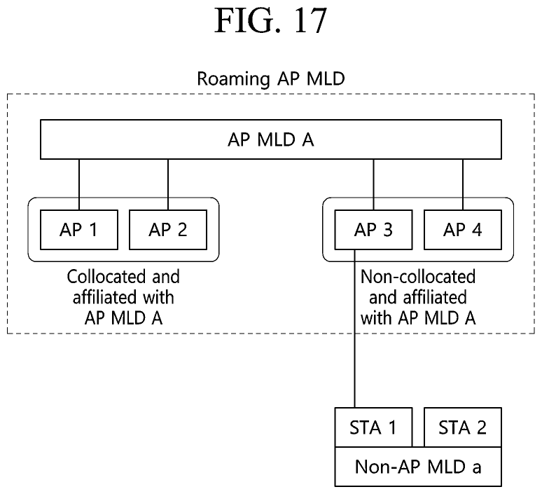

FIG. 17 illustrates the configuration after roaming in accordance with an embodiment. In particular, STA 1 in non-AP MLD a is no longer active with AP 1 in Roaming AP MLD. The data path is re-routed to AP 3 in Roaming AP MLD. AP 3 keeps the context of Roaming AP MLD for the client.

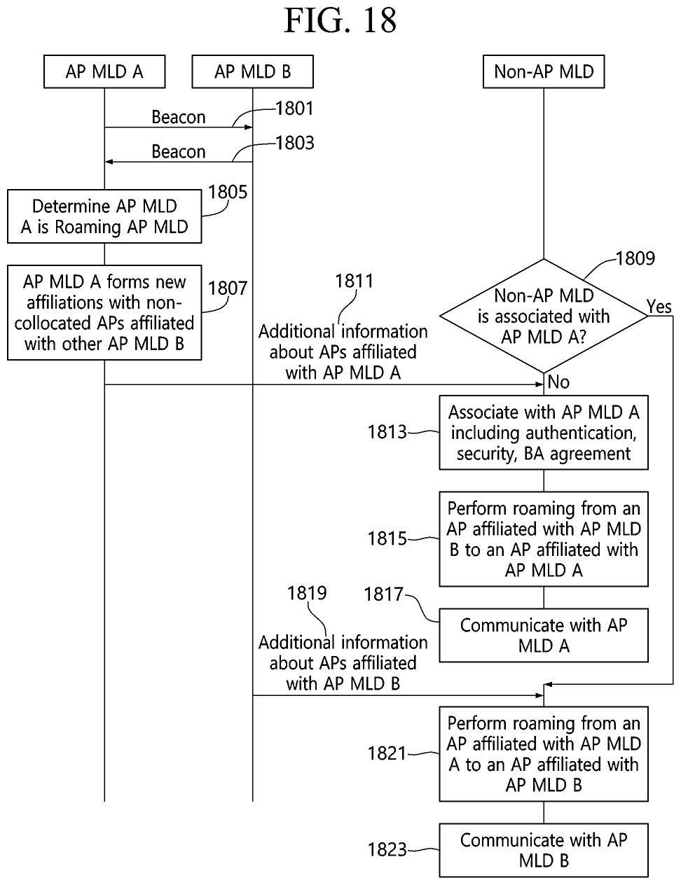

FIG. 18 illustrates a ladder diagram for configuring roaming between AP MLDs in accordance with an embodiment. AT 1801 the AP MLD A may transmit a beacon frame to AP MLD B. At 1803, the AP MLD B may transmit a beacon frame to AP MLD A. The beacon frames may include information about the current traffic status and/or buffer capacity in the AP MLDs. In some embodiments, the beach frame may be transmitted by an AP affiliated with the AP MLD. The beacon frames may include information to notify other nearby AP MLDs that the AP MLD transmitting the beacon frame has the capability of supporting roaming operation and can be a candidate for Roaming AP MLD.

At 1805, AP MLD A determines that it is the roaming AP MLD. In some embodiments, the determination may be made by comparing the stacked traffic of the buffer in AP MLD A with the stacked traffic in AP MLD B, and the AP MLD with a larger buffer size and/or a smaller amount of stacked traffic may become the Roaming AP MLD.

At 1807, AP MLD A forms new affiliations with non-collocated APs affiliated with other AP MLD B.

At 1809, non-AP MLD determines whether it is associated with AP MLD A.

If at 1809, non-AP MLD determines that it is not associated with AP MLD A, non-AP MLD performs operations 1811, 1813, 1815, and 1817. In particular, at 1811 non-AP MLD A receives additional information about APs affiliated with AP MLD A. At 1813, non-AP MLD associates with AP MLD A, including authentication, security, and/or BA agreement based on the received additional information. At 1815, non-AP MLD performs roaming from an AP affiliated with AP MLD B to an AP affiliated with AP MLD A based on the received additional information. At 1817, non-AP MLD communicates with AP MLD A.

If at 1809, non-AP MLD determines that it is associated with AP MLD A, non-AP MLD performs operations 1819, 1821 and 1823. In particular, at 1819 non-AP MLD receives additional information about APs affiliated with AP MLD B. At 1821, non-AP MLD performs roaming from an AP affiliated with AP MLD A to an AP affiliated with AP MLD B based on the received additional information. At 1823, non-AP MLD communicates with AP MLD B.

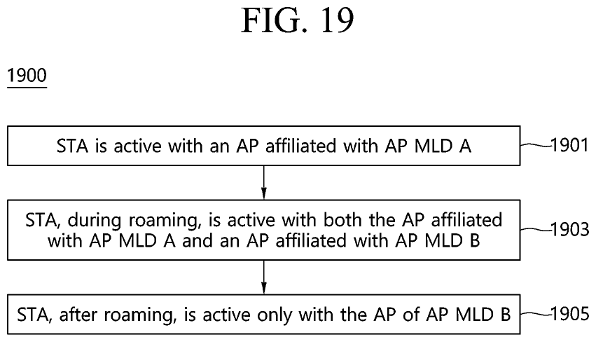

FIG. 19 illustrates a flow chart of an example process for roaming between AP MLDs in accordance with an embodiment. The process 1900, in operation 1901 an STA is active with an AP affiliated with AP MLD A. In operation 1903, the STA, during roaming, is active with both the AP affiliated with AP MLD A and an AP affiliated with AP MLD B. In operation 1905, the STA, after roaming, is active only with the AP of AP MLD B.

To illustrate the interchangeability of hardware and software, items such as the various illustrative blocks, modules, components, methods, operations, instructions, and algorithms have been described generally in terms of their functionality. Whether such functionality is implemented as hardware or software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point multi-link device (AP MLD) for connecting to a wireless network, the first AP MLD comprising:
one or more APs affiliated with the first AP MLD, including a first AP;
a processor coupled to the first AP, the processor configured to:
communicate with a second AP MLD to determine that the first AP MLD is a roaming AP MLD;
form affiliation with a second AP of one or more non-collocated APs affiliated with a second AP MLD;
transmit information about the first AP affiliated with the first AP MLD to a non-AP MLD associated with the second AP MLD;
associate with the non-AP MLD; and
communicate with the non-AP MLD via the first AP MLD after the non-AP MLD performs roaming from the second AP MLD to the first AP MLD.

2. The first AP MLD of claim 1, wherein the communicating with the second AP MLD to determine that the first AP MLD is the roaming AP MLD comprises:
receiving, from the second AP MLD, a frame that include information for determining which AP MLD can be the roaming AP MLD; and
determining that the first AP MLD is the roaming AP MLD based on the information in the frame.

3. The first AP MLD of claim 2, wherein the frame is a beacon frame.

4. The first AP MLD of claim 2, wherein the frame includes traffic status information of the second AP MLD.

5. The first AP MLD of claim 4, wherein determining that the first AP MLD is the roaming AP MLD comprises:
comparing a stacked traffic amount of the first AP MLD with a stacked traffic amount indicated by the traffic status information of the second AP MLD, and
determining that the first AP MLD is the roaming AP MLD if the stacked traffic amount of the first AP MLD is smaller than the stacked traffic amount of the second AP MLD.

6. The first AP MLD of claim 2, wherein the frame includes buffer capacity information of the second AP MLD.

7. The first AP MLD of claim 6, wherein determining that the first AP MLD is the roaming AP MLD comprises:
comparing a size of a buffer of the first AP MLD with a buffer size indicated by the buffer capacity information of the second AP MLD, and
determining that the first AP MLD is the roaming AP MLD if the size of the buffer of the first AP MLD is larger than the buffer size indicated by the buffer capacity information of the second AP MLD.

8. The first AP MLD of claim 1, wherein associating with the non-AP MLD comprises performing at least one of authentication, security, and block acknowledgement agreement with the non-AP MLD.

9. A non-access point multi-link device (non-AP MLD) for connecting to a wireless network, comprising processing circuitry configured to:
associate with a first AP affiliated with a first AP MLD;
communicate with the first AP affiliated with the first AP MLD;
receive information about a second AP MLD;
associate with a second AP affiliated with the second AP MLD and the first AP MLD, wherein the first AP and the second AP is non-collocated;
perform roaming from the first AP affiliated with the first AP MLD to the second AP affiliated with the second AP MLD; and
communicate with the second AP affiliated with the second AP MLD.

10. The non-AP MLD of claim 9, wherein the processing circuitry is further configured to associate with the second AP affiliated with the second AP MLD by performing at least one of authentication, security, and block acknowledgement agreement with the second AP MLD.

11. The non-AP MLD of claim 9, wherein the processing circuitry is further configured to, during roaming, being active with both the first AP affiliated with the first AP MLD and the second AP affiliated with the second AP MLD.

12. The non-AP MLD of claim 11, wherein the processing circuitry is further configured to, after roaming, be active with only the second AP affiliated with the second AP MLD.

13. A computer-implemented method for facilitating communication in a wireless network, the method comprising:
communicating, by a first access point (AP) affiliated with a first AP multi-link device (MLD), with a second AP MLD to determine that the first AP MLD is a roaming AP MLD;
forming affiliations with a second AP of one or more non-collocated APs affiliated with a second AP MLD;
transmitting information about the first AP affiliated with the first AP MLD to a non-AP MLD associated with the second AP MLD;
associating with the non-AP MLD; and
communicating with the non-AP MLD via the first AP MLD after the non-AP MLD performs roaming from the second AP MLD to the first AP MLD.

14. The computer implemented method of claim 13, wherein the communicating with the second AP MLD to determine that the first AP MLD is the roaming AP MLD comprises:
receiving, from the second AP MLD, a frame that include information for determining which AP MLD can be the roaming AP MLD, and
determining that the first AP MLD is the roaming AP MLD based on the information in the frame.

15. The computer implemented method of claim 14, wherein the frame is a beacon frame.

16. The computer implemented method of claim 14, wherein the frame includes traffic status information of the second AP MLD.

17. The computer implemented method of claim 16, wherein determining that the first AP MLD is the roaming AP MLD comprises:
comparing a stacked traffic amount of the first AP MLD with a stacked traffic amount indicated by the traffic status information of the second AP MLD, and
determining that the first AP MLD is the roaming AP MLD if the stacked traffic amount of the first AP MLD is smaller than the stacked traffic amount of the second AP MLD.

18. The computer implemented method of claim 14, wherein the frame includes buffer capacity information of the second AP MLD.

19. The computer implemented method of claim 18, wherein determining that the first AP MLD is the roaming AP MLD comprises:
comparing a size of a buffer of the first AP MLD with a buffer size indicated by the buffer capacity information of the second AP MLD, and
determining that the first AP MLD is the roaming AP MLD if the size of the buffer of the first AP MLD is larger than the buffer size indicated by the buffer capacity information of the second AP MLD.

20. The computer implemented method of claim 13, wherein associating with the non-AP MLD comprises performing at least one of authentication, security, and block acknowledgement agreement with the non-AP MLD.
